(19) United States
(12) Patent Application Publication
(10) Pub. No.: US 2017/0285953 A1
(43) Pub. Date: Oct. 5, 2017

(54) Data Storage Device and Data Maintenance Method thereof

(71) Applicant: Silicon Motion, Inc., Jhubei City (TW)

(72) Inventor: Yu-Wei FAN, Taipei City (TW)

(21) Appl. No.: 15/436,918

(22) Filed: Feb. 20, 2017

(30) Foreign Application Priority Data
Mar. 31, 2016 (TW) 105110254

(51) Int. Cl. G06F 3/06

(52) U.S. Cl. CPC G06F 3/064; G06F 3/0604; G06F 3/0647; G06F 3/065; G06F 3/0659; G06F 3/0679

(57) ABSTRACT

The present invention provides a data storage device including a flash memory and a controller. The flash memory has a plurality of first type spare blocks and a plurality of second type spare blocks, wherein the second type spare blocks are capable to store more data volume than the first type spare blocks. The controller writes data into the first type spare blocks, defines the first type spare blocks as first type data blocks if stored with data. When a predetermined condition is satisfied, the controller starts to move/copy valid data of a plurality of oldest first type data blocks into one of the second type spare blocks.

### CROSS REFERENCE TO RELATED APPLICATIONS

This Application claims priority of Taiwan Patent Application No. 105110254, filed on Mar. 31, 2016, the entirety of which is incorporated by reference herein.

### BACKGROUND OF THE INVENTION

### Field of the Invention

The present invention is related to a data maintenance method of a data storage device, and in particular related to a data maintenance method for Triple-Level Cell.

### Description of the Related Art

Flash memory is considered a non-volatile data-storage device, using electrical methods to erase and program itself NAND Flash, for example, is often used in memory cards, USB flash devices, solid state devices, eMMCs, and other memory de vices.

Flash memory such as NAND Flash uses a multiple-block structure to store data, wherein the flash memory uses floating gate transistors. The floating gates of the floating gate transistor may catch electronic charges for storing data. However, the electronics might undergo loss from the floating gate due to the operation of the flash memory or various environmental parameters, which can affect data retention. The writing process of the Triple-Level Cell (TLC) is more complicated than the other types of cells of the flash memory. Therefore, a stable and efficient writing process for the Triple-Level Cell is needed.

### BRIEF SUMMARY OF THE INVENTION

A detailed description is given in the following embodiments with reference to the accompanying drawings.

An exemplary embodiment provides a data storage device including a flash memory and a controller. The flash memory has a plurality of first type spare blocks and a plurality of second type spare blocks, wherein the second type spare blocks are capable to store more data volume than the first type spare blocks. The controller writes data into the first type spare blocks in response to a write command, defines the first type spare blocks as a plurality of first type data blocks if stored with data, wherein when a predetermined condition is satisfied, the controller starts to move/copy valid data of a plurality of oldest first type data blocks into one of the second type spare blocks, wherein a plurality of logical addresses of the valid data are mapped to the oldest first type data blocks.

Another exemplary embodiment provides a data storage device including a flash memory and a controller. The flash memory has a plurality of SLC-spare blocks, a plurality of SLC-data blocks and a plurality of TLC-spare blocks. The controller rites data into the SLC-spare blocks in response to a write command arranged to write the data into the flash memory, wherein the controller writes a first part of the data into a first group SLC-spare blocks comprising three of the SLC-spare blocks when a predetermined condition is satisfied, and before writing other parts of the data into the other SLC-spare blocks, the controller selects a second group SLC-data blocks comprising three of the SLC-data blocks which have the oldest valid data from the SLC-data blocks, and moves/copies the data stored in the second group SLC-data blocks into one of the TLC-spare blocks to release the second group SLC-data blocks.

Another exemplary embodiment provides a data maintenance method applied to a data storage device having a flash memory, wherein the flash memory has a plurality of first type spare blocks and a plurality of second type spare blocks, and the second type spare blocks are capable to store more data volume than the first type spare blocks. The data maintenance method includes: writing data into the first type spare blocks in response to a write command; defining the first type spare blocks as a plurality of first type data blocks if stored with data; determining whether a predetermined condition is satisfied; when the predetermined condition is satisfied, starting to move/copy valid data of a plurality of oldest first type data blocks into one of the second type spare blocks, wherein a plurality of logical addresses of the valid data are mapped to the oldest first type data blocks.

Another exemplary embodiment further provides a data maintenance method applied to a data storage device having a flash memory, wherein the flash memory has a plurality of SLC-spare blocks, and a plurality of SLC-data blocks and a plurality of TLC-spare blocks. The data maintenance method includes: receiving a write command arranged to write data into the flash memory; and writing the data into the SLC-spare blocks in response to the write command, wherein when a predetermined condition is satisfied, the step of writing the data into the SIC-spare blocks further includes: writing the first part of the data into a first group SLC-spare blocks including three of the SLC-spare blocks; and before writing the remaining of the data into the other SLC-spare blocks, selecting a second group SLC-data blocks which have valid data for the longest time from the SLC-data blocks, and moving/coping the data stored in the first SLC-data blocks into one of the TLC-spare blocks to release the second group SLC-data blocks.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an electronic system in accordance with an embodiment.

FIG. 2 is a schematic diagram illustrating a flash memory in accordance with an embodiment.

FIG. 3A-3B is a flowchart of a data maintenance method in accordance with an embodiment.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

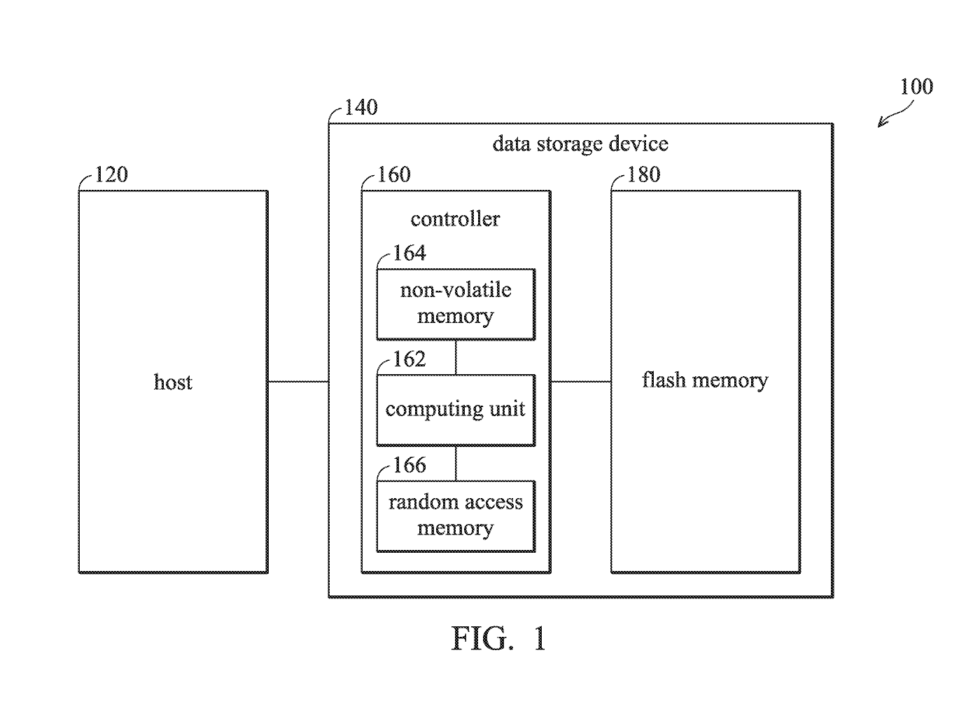

FIG. 1 is a schematic diagram illustrating an electronic system in accordance with an embodiment. The electronic system 100 includes a host 120 and a data storage device 140. The data storage device 140 includes a flash memory 180 and a controller 160, and operates in response to the commands of the host 120. The controller 160 includes a computing unit 162, a non-volatile memory 164 (ROM) and a random access memory 166 (RAM). The non-volatile memory 164, the program code stored in the non-volatile memory 164 and data stored in the non-volatile memory 164 constitute firmware executed by the processing unit 162, and the controller 160 is configured to control the flash memory 180 based on the firmware. The flash memory 180 includes a plurality of blocks, each of the blocks has a plurality of pages, wherein the minimum write unit of the flash memory 180 is a page, and the minimum erase unit of the flash memory 180 is a block.

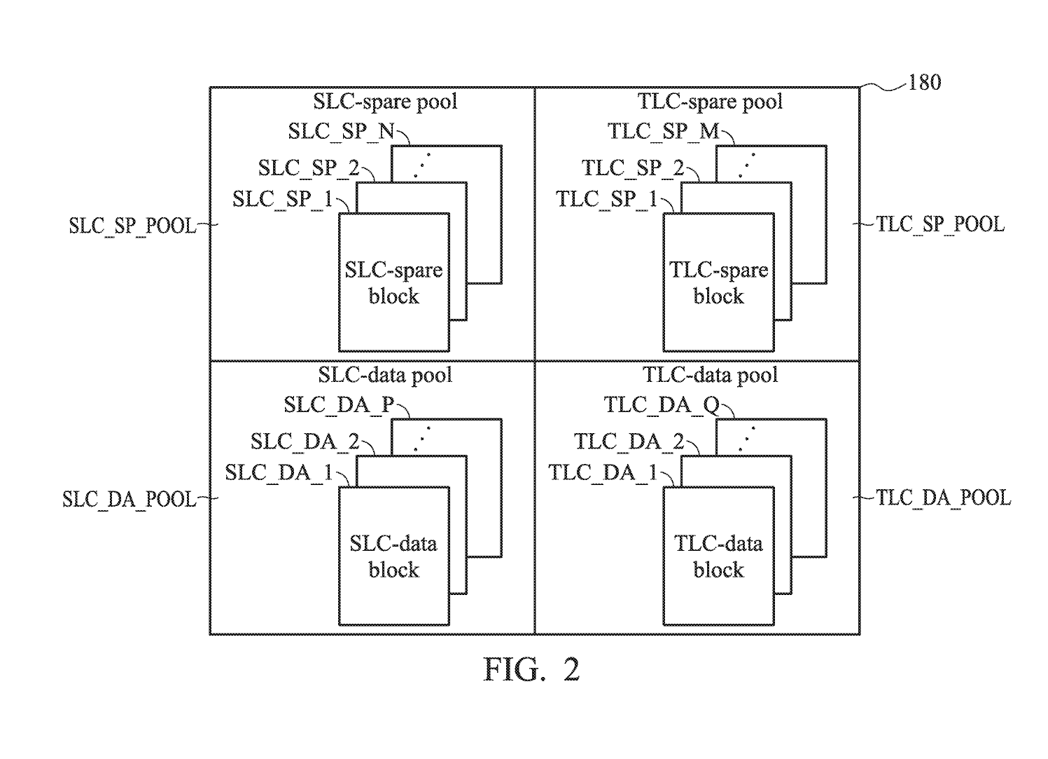

FIG. 2 is a schematic diagram illustrating a flash memory in accordance with an embodiment. As shown in FIG. 2, the flash memory 180 has a SLC-spare pool SLC_SP_POOL, a TLC-spare pool TLC_SP_POO, a SLC-data pool SLC_DA_POOL and a TLC-data pool TLC_DA_POOL. The SLC-spare pool SLC_SP_POOL includes a plurality of SLC-spare blocks SLC_SP_1˜SLC_SP_N, wherein “SLC” is the abbreviation of “Single-Level Cell”, the total number of SLC-spare blocks is “N”, and the size of SLC-spare block is equal to the block, but it is not limited thereto. Namely, the SLC-spare blocks SLC_SP_1˜SLC_SP_N is SLC blocks that are without valid data, and the SLC-spare blocks SLC_SP_1˜SLC_SP_N are the blocks of the flash memory 180 that are arranged to be written by either its default way or a SLC storage mode (make a TLC block work as a SLC block simulative). It should be noted that, after any of the SLC-spare blocks SLC_SP_1˜SLC_SP_N in the SLC-spare pool SLC_SP_POOL is written by valid data, the SLC-spare block with valid data will be defined as a SLC-data block (new SLC-data block) and pushed into the SLC-data pool SLC_DA_POOL. The SLC-data pool SLC_DA_POOL includes a plurality of SLC-data blocks SLC_DA_1˜SLC_DA_P, wherein “P” is the total number of SLC-data blocks in the SLC-data pool SLC_DA_POOL, and the size of the SLC-data blocks is equal to a block, but it is not limited thereto. Namely, the SLC-data blocks SLC_DA_1˜SLC_DA_P are the SLC blocks that have valid data, and the valid data of the SLC-data blocks SLC_DA_1 ˜SLC_DA_P is arranged to be written into the TLC-spare blocks by TLC storage mode. It should be noted that, after the valid data stored in the SLC-data block in the SLC-data pool SLC_DA_POOL is programed (written) into the TLC-spare block, the SLC-data block will be defined as the SLC-spare block and pushed into the SLC-spare pool SLC_SO_POOL. The TLC-spare pool TLC_SP_POOL includes a plurality of TLC-spare blocks TLC_SP_0˜TLC_SP_M, wherein “TLC” is the abbreviation of “Triple-Level Cell”, and “M” is the total number of TLC-spare blocks TLC_SP_0˜TLC_SP_M in the TLC-spare pool TLC_SP_POOL, and the size of the TLC-spare block is equal to the block. Namely, the TLC-spare blocks TLC_SP_0˜TLC_SP_M are the TLC blocks without valid data, and the TLC-spare blocks TLC_SP_0˜TLC_SP_M are the blocks that have valid data written by TLC storage mode. More specifically, the data written into the TLC-spare blocks TLC_SP_0˜TLC_SP_M was stored in the SLC-data blocks. It should be noted that the TLC-spare block having valid data will be defined as the TLC-data block (new TLC-data block) and pushed into the TLC-data pool TLC_DA_POOL. The TLC-data pool TLC_DA_POOL includes a plurality of TLC-data blocks TLC_DA_1˜TLC_DA_Q, wherein “Q” is the total number of TLC-data blocks in the TLC-data pool TLC_DA_POOL, and the size of the TLC-data block is equal to the block, but it is not limited thereto. Namely, the TLC-data blocks TLC_DA_1˜TLC_DA_Q are the TLC blocks that have valid data. It should be noted that, when the valid data stored in the TLC-data block in TLC-data pool TLC_DA_POOL is invalidated, the TLC-data block will be defined as the TLC-spare block (a new TLC-spare block) and pushed into the TLC-spare pool TLC_SP_POOL.

It should be noted that, before any data is written into the flash memory 180, the TLC-data pool TLC_DA_POOL does not have any TLC-data block and the SLC-data pool SLC_DA_POOL does not have any SLC-data block.

Moreover, the memory space of each of the TLC-data blocks TLC_DA_1˜TLC_DA_Q and the TLC-spare blocks TLC_SP_1˜TLC_SP_M is three times the memory space of each of the SLC-data blocks SLC_DA_1˜SLC_DA_P and the SLC-spare blocks SLC_SP_1˜SLC_SP_N. More specifically, the TLC blocks and the SLC blocks are the blocks of the flash memory 180, the physical structure of the TLC block and the SLC block are the same. However, the controller has to program the TLC block by a specific voltage several times to write data into the TLC block, and the controller only has to program the SLC block one time to write data into the SLC block. In one embodiment, the controller has to program the TLC block by a specific voltage three times to write data into the TLC block. Namely, the data stored in three SLC-data blocks can be written into one TLC-data block.

The SLC block is more stable than the TLC block, so that, in one of the embodiments of the present invention, the function of SLC blocks is arranged to cache data. Namely, the SLC blocks serve as the cache memory for temporarily storing data before the data is written into the TLC blocks. In one embodiment, the controller 160 starts to write the data stored in the SLC blocks into the TLC blocks when the SLC blocks are almost consumed (the number of SLC-data blocks is greater than a predetermined amount). Although moving the data of the SLC-data blocks to the TLC blocks can increase the number of SLC-spare blocks, the controller 160 will not be able to finish the tasks indicated by the user or other devices timely and the performance (read or write) will suffer. Therefore, in one of the embodiments, based on the features of the SLC block and TLC block, the controller 160 may alternatively execute the write operation and the clear operation of the SLC data block to ensure that the SLC-spare block of the flash memory 180 will be provided adequately and the write operation indicated by the host will be finished smoothly.

More specifically, when the controller 160 receives a write command arranged to write data into the flash memory 180 from the host 120, the controller 160 writes the data into the SLC-spare blocks in response to the write command. Moreover, before any of the SLC-spare blocks is written, the controller 160 determines whether the number of SLC-spare blocks SLC_SP_1˜SLC_SP_N is less than a predetermined amount to determine whether a predetermined condition is satisfied. When the number of SLC-spare blocks SLC_SP_1˜SLC_SP_N is less than the predetermined amount, the predetermined condition is satisfied. When the predetermined condition is satisfied, the controller 160 starts to clear the SLC-data blocks SLC_DA_1˜SLC_DA_P. Namely, when the predetermined condition is satisfied, the controller 160 moves/copies the valid data of three oldest SLC data blocks from the SLC data blocks SLC_DA_1˜SLC_DA_P into one of the TLC spare blocks TLC_SP_1˜TLC_SP_M when every three of the SLC spare blocks are written. It should be noted that, in one embodiment, the data storage device 140 has a block maintenance table arranged to record how long the valid data has existed in each of the SLC-data blocks SLC_DA_1˜SLC_DA_P in the SLC-data pool SLC_DA_POOL, but it is not limited thereto. In other embodiments, the data storage device 140 may use other methods to record when or the sequence of the valid data has programmed in each of the SLC-data blocks SLC_DA_1˜SLC_DA_P in the SLC-data pool SLC_DA_POOL. Moreover, when the predetermined condition is not satisfied, the controller 160 writes the data into the SLC-spare blocks without clearing the SLC-data blocks, and determines whether the predetermined condition is satisfied before any of the SLC-spare blocks is written. In another embodiment, the predetermined condition may include any situation that needs to clear the SLC-data blocks.

In one embodiment, the controller 160 maps at least one logical address of the written data to the written SLC-spare blocks and defines the written SLC-spare blocks as the new SLC-data blocks (step S312) after moving/copying the data of the SLC-data block having the longest valid data into one of the TLC-spare blocks TLC_SP_1˜TLC_SP_M (step S310). When a power off event or another interruption occurs during the process of moving/copying data into the TLC-spare block, the original data is still stored in the original SLC-data block. Therefore, the data can also be kept in the SLC block, which is more stable than the TLC block.

For example, when the predetermined condition is satisfied, the controller 160 writes a first part of the data into three of the SLC spare blocks. Next, before a remaining part of the data are written into the other SLC-spare blocks, the controller 160 selects three oldest (first group) SLC-data blocks, which have the oldest valid data, from the SLC-data blocks SLC_DA_1˜SLC_DA_P and moves/copies the data stored in the first group SLC-data blocks into one of the TLC-spare blocks in order to release the first group SLC-data blocks, wherein the mapping between the released first group SLC-data blocks and the original data is lost, and the released first group SLC-data blocks are re-defined as SLC-spare blocks. Next, after the first group SLC-data blocks are released, the controller 160 maps at least one logical address of the first part of the data to the three SLC-spare blocks, and defines the three SLC-spare blocks as three new SLC-data blocks.

After defining the first SLC-spare blocks as the SLC-data blocks, the controller 160 writes a second part of the data into another three of the SLC-spare blocks SLC_DA_1˜SLC_DA_P. before the remaining of the data are written into the other SLC-spare blocks, the controller 160 selects the three oldest (second group) SLC-data blocks, which have the oldest valid data, from the SLC-data blocks SLC_DA_1˜SLC_DA_P and moves/copies the data stored in the second group SLC-data blocks into one of the TLC-spare blocks in order to release the second group SLC-data blocks, wherein the mapping between the released second group SLC-data blocks and the original data is lost, and the released second SLC-data blocks are re-defined as SLC-spare blocks. Next, after the second group SLC-data blocks are released, the controller 160 maps at least one logical address of the second part of the data to the second group SLC-spare blocks, and defines the second group SLC-spare blocks as three new SLC-data blocks. Next the controller 160 repeats the above steps until all of the data is written into the SLC-spare blocks. Moreover, the volume of the first part and second part of the data is able to be stored into three SLC blocks.

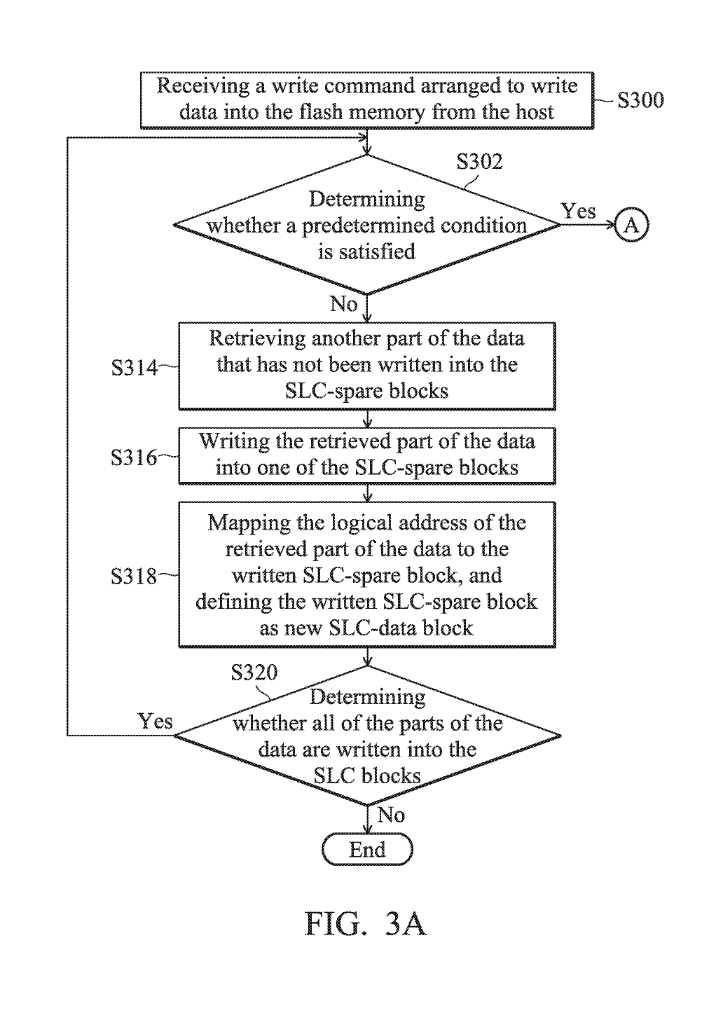

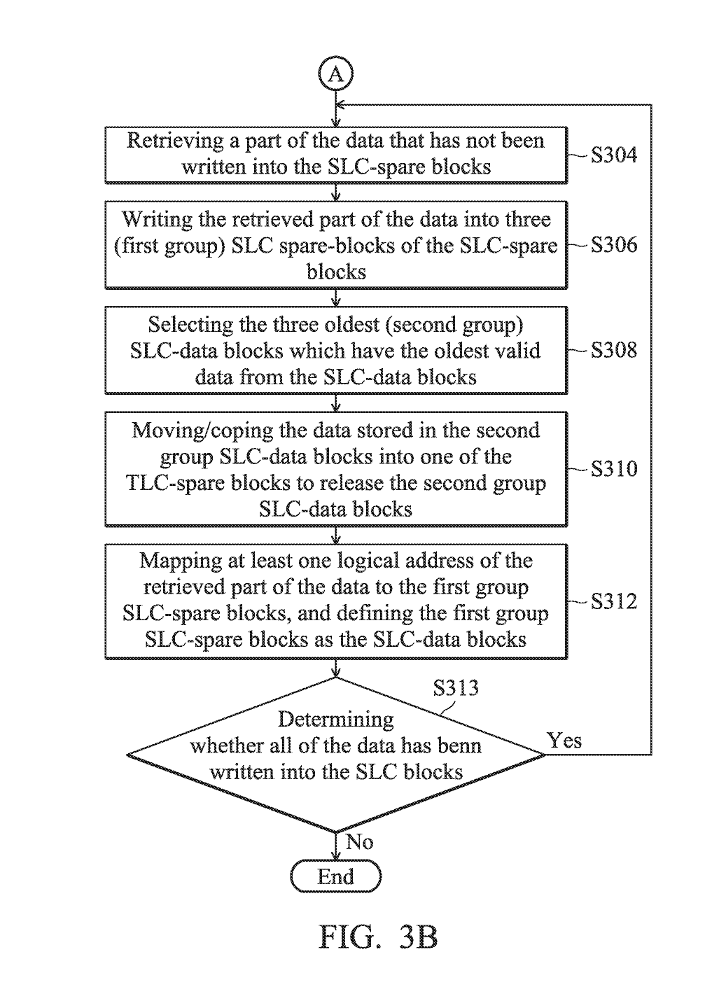

FIG. 3A-3B is a flowchart of a data maintenance method in accordance with an embodiment. The data maintenance method is applied to the data storage device 140 of FIG. 1. The process starts at step S300.

In step S300, the controller 160 receives a write command arranged to write data into the flash memory 180 from the host 120. In this embodiment, the volume of the data is larger than the volume of one SLC block, but it is not limited thereto.

Next, in step S302, the controller 160 determines whether a predetermined condition is satisfied. In one embodiment the controller 160 determines whether the number of SLC-spare blocks SLC_SP_1˜SLC_SP_N is less than a predetermined amount to determine whether the predetermined condition is satisfied. When the number of SLC-spare blocks SLC_SP_1˜SLC_SP_N is less than the predetermined amount, the predetermined condition is satisfied. More specifically, when the predetermined condition is satisfied, the process goes to step S304 to start clearing the SLC-data blocks SLC_DA_1˜SLC_DA_P. When the predetermined condition is not satisfied, the process goes to step S314. In the other embodiments, the predetermined condition may include any situation that needs to clear the SLC-data blocks.

In step S304, the controller 160 retrieves a part of the data that has not been written into the SLC-spare blocks. More specifically, the controller 160 retrieves the part of the data, which follows previously data, and the volume of the part of the data is able to be stored into three SLC blocks. If the volume of the data is less than the memory space of three SLC blocks, the controller 160 retrieves all of the data.

Next, in step S306, the controller 160 writes the retrieved part of the data into three (first group) SLC spare-blocks of the SLC-spare blocks SLC_SP_1˜SLC_SP_N. Namely, the controller 160 writes the part of the data that is retrieved in the step S304 into three of the SLC-spare blocks SLC_SP_1˜SLC_SP_N.

Next, in step S308, the controller 160 selects the three oldest (second group) SLC-data blocks which have the oldest valid data from the SLC-data blocks SLC_DA_1˜SLC_DA_P. Namely, the controller 160 selects three SLC-data blocks that have the coldest data from the SLC-data blocks SLC_DA_1˜SLC_DA_P.

Next, in step S310, the controller 160 moves/copies the data stored in the second group SLC-data blocks into one of the TLC-spare blocks to release the second group SLC-data blocks, wherein the mapping between the data and the second group SLC-data blocks are lost, and the released second group SLC-data blocks are defined as new SLC-spare blocks.

Next, in step S312, the controller 160 maps at least one logical address of the retrieved part of the data to the first group SLC-spare blocks, and defines the first group SLC-spare blocks as new SLC-data blocks. Namely, the controller 160 maps at least one logical address of the part of data, which is retrieved in step S304, to the first group SLC-spare blocks written in step S306, and defines the first group SLC-spare blocks written in step S306 as new SLC-data blocks.

In step S313, the controller 160 determines whether all of the data has been written into the SLC blocks. If not all of the data indicated by the received write command is written into the SLC blocks, the process returns to step S304 to continuously write the remaining of the data into the SLC-spare blocks and clear the SLC-data blocks. If all of the data is written into the SLC blocks, the process ends at step S313. It should be noted that, in another embodiment, when not all of the data is written into the SLC blocks, the process returns to step S302 to determine whether the predetermined condition is satisfied.

In step S314, the controller 160 retrieves another part of the data that has not been written into the SLC-spare blocks. More specifically, the controller 160 reeves the next part of the data, which follows the previously retrieved part of the data, wherein the volume of the next part of the data is able to be stored into one SLC block. When the volume of remaining data is less than the memory space of one SLC block, the controller 160 retrieves all of the remaining data.

In step S316, the controller 160 writes the retrieved part of the data into one of the SLC-spare blocks SLC_SP_1˜SLC_SP_N. Namely, the controller 160 writes the part of the data retrieved in step S314 into one of the SLC-spare blocks SLC_SP_1˜SLC_SP_N.

Next, in step S318, the controller 160 maps the logical address of the retrieved part of the data to the written SLC-spare block, and defines the written SLC-spare block as new SLC-data block. Namely, the controller 160 maps the logical address of the part of the data that was retrieved in step S314 to the SLC-spare block that is written in step S316, and defines the SLC-spare block that is written in step S316 as a new SLC-data block.

In step S320, the controller 160 determines whether all of the data are written into the SLC blocks. If not all of the data is written to the SLC-spare block, the process returns to step S302. If all of the data is written into the SLC-spare blocks, the process ends at step S320.

As described above, in steps S304˜S313, the controller 160 moves/copies the data stored in the three oldest SLC-data block SLC_DA_1˜SLC_DA_P that have the oldest valid data into one of the TLC-spare blocks TLC_SP_1˜TLC_SP_M. In steps S314˜S320, the controller 160 continuously writes the data into the SLC-spare blocks, and determines whether the predetermined condition is satisfied before any of the SLC-spare blocks is written.

The data storage device and the data maintenance method may provide SLC-spare blocks in order to write the data into the SLC-spare blocks smoothly.

Data transmission methods, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a flash memory, having a plurality of first type spare blocks and a plurality of second type spare blocks, wherein the second type spare blocks are capable to store more data volume than the first type spare blocks; and
a controller, writing data into the first type spare blocks in response to a write command, defining the first type spare blocks as a plurality of first type data blocks if stored with data, wherein when a predetermined condition is satisfied, the controller starts to move/copy valid data of a plurality of oldest first type data blocks into one of the second type spare blocks, wherein a plurality of logical addresses of the valid data are mapped to the oldest first type data blocks.

2. A data storage device as claimed in claim 1, wherein the second type spare block is defined as a second type data block when the move/copy is done, and the logical addresses of the valid data are not mapped to the oldest first type of data blocks but the second type data block.

3. A data storage device as claimed in claim 1, wherein when a number of first type spare blocks is less than a predetermined amount, the predetermined condition is satisfied.

4. A data storage device as claimed in claim 1, wherein when the predetermined condition is not satisfied, the controller continuously writes data into the first type spare blocks in response to the write command.

5. A data storage device as claimed in claim 1, wherein the first type spare blocks are first type blocks that do not have valid data, the first type data blocks are first type blocks that have valid data, and the second type spare blocks are second type blocks that do not have valid data.

6. A data storage device as claimed in claim 1, wherein the first type spare blocks are SLC spare blocks, the first type data blocks are SLC data blocks and the second type spare blocks are TLC spare blocks.

7. A data storage device as claimed in claim 1, wherein the first type spare blocks are simulated by the second type spare blocks.

8. A data storage device as claimed in claim 1, wherein the first type spare blocks and the second type spare blocks are different types of data blocks.

9. A data storage device, comprising:
a flash memory, having a plurality of SLC-spare blocks, a plurality of SLC-data blocks and a plurality of TLC-spare blocks; and
a controller, writing data into the SLC-spare blocks in response to a write command arranged to write the data into the flash memory, wherein the controller writes a first part of the data into a first group SLC-spare blocks comprising three of the SLC-spare blocks when a predetermined condition is satisfied, and before writing other parts of the data into the other SLC-spare blocks, the controller selects a second group SLC-data blocks comprising three of the SLC-data blocks which have the oldest valid data from the SLC-data blocks, and moves/copies the data stored in the second group SLC-data blocks into one of the TLC-spare blocks to release the second group SLC-data blocks.

10. A data storage device claimed as claim 9, wherein after the first SLC-data blocks are released, the controller maps at least one logic address of the first part of the data to the first group SLC-spare blocks, and defines the first group SLC-spare blocks as three of the SLC-data blocks.

11. A data storage device claimed as claim 10, wherein the controller writes a second part of the data into a third group SLC-spare blocks comprising three of the SLC-spare blocks after the first group SLC-spare blocks are defined as three of the SLC-data blocks, and the controller further selects fourth group SLC-data blocks comprising three of the SLC-data blocks which have the oldest valid data from the SLC-data blocks and moves/copies the data stored in the third group SLC-data blocks into one of the TLC-spare blocks to release the fourth group SLC-data blocks before the remaining of the data are written into the other SLC-spare blocks.

12. A data storage device claimed as claim 9, wherein before any of the SLC-spare blocks is written, the controller determines whether the number of SLC-spare blocks is less than a predetermined amount, and when the number of SLC-spare blocks is less than the predetermined amount, the predetermined condition is satisfied.

13. A data storage device claimed as claim 9, wherein when the predetermined condition is not satisfied, the controller continuously writes the data into the SLC-spare blocks.

14. A data storage device claimed as claim 9, wherein the SLC-spare blocks are SLC blocks that do not have valid data, the SLC-data blocks are SLC blocks that have valid data, and the TLC-spare blocks are TLC blocks that do not have valid data.

15. A data maintenance method, applied to a data storage device having a flash memory, wherein the flash memory has a plurality of first type spare blocks and a plurality of second type spare blocks, and the second type spare blocks are capable to store more data volume than the first type spare blocks, the data maintenance method comprising:
writing data into the first type spare blocks in response to a write command;
defining the first type spare blocks as a plurality of first type data blocks if stored with data;
determining whether a predetermined condition is satisfied; and
when the predetermined condition is satisfied, starting to move/copy valid data of a plurality of oldest first type data blocks into one of the second type spare blocks, wherein a plurality of logical addresses of the valid data are mapped to the oldest first type data blocks.

16. The data maintenance method as claimed in claim 15, wherein the second type spare block is defined as a second type data block when the move/copy is done, and the logical addresses of the valid data are not mapped to the oldest first type of data blocks but the second type data block.

17. The data maintenance method as claimed in claim 15, wherein when a number of first type spare blocks is less than a predetermined amount, the predetermined condition is satisfied.

18. The data maintenance method as claimed in claim 15, further comprising continuously writing data into the first type spare blocks in response to the write command when the predetermined condition is not satisfied.

19. The data maintenance method as claimed in claim 15, wherein the first type spare blocks are first type blocks that do not have valid data, the first type data blocks are first type blocks that have valid data, and the second type spare blocks are second type blocks that do not have valid data.

20. The data maintenance method as claimed in claim 15, wherein the first type spare blocks are SLC spare blocks, the first type data blocks are SLC data blocks and the second type spare blocks are TLC spare blocks.

21. The data maintenance method as claimed in claim 15, wherein the first type spare blocks are simulated by the second type spare blocks.

22. The data maintenance method as claimed in claim 15, wherein the first type spare blocks and the second type spare blocks are different types of data blocks.

23. A data maintenance method, applied to a data storage device having a flash memory, wherein the flash memory has a plurality of SLC-spare blocks, a plurality of SLC-data blocks and a plurality of TLC-spare blocks, the data maintenance method comprising:
receiving a write command arranged to write data into the flash memory; and
writing the data into the SLC-spare blocks in response to the write command, wherein when a predetermined condition is satisfied, the step of writing the data into the SLC-spare blocks further comprises:
writing a first part of the data into a first group SLC-spare blocks comprising three of the SLC-spare blocks; and
before writing the remaining of the data into the other SLC-spare blocks, selecting a second group SLC-data blocks comprising there of the SLC-data blocks which have the oldest valid data from the SLC-data blocks, and moving/coping the data stored in the second group SLC-data blocks into one of the TLC-spare blocks to release the second group SLC-data blocks.

24. The data maintenance method as claimed in claim 23, wherein when the predetermined condition is satisfied, the step of writing the data into the SLC-spare blocks further comprises:
after the second group SLC-data blocks are released, mapping at least one logic address of the first part to the first group SLC-spare blocks, and defining the first group SLC-spare blocks as new SLC-data blocks.

25. The data maintenance method as claimed in claim 24, when the predetermined condition is satisfied, the step of writing the data into the SLC-spare blocks further comprises:
after defining the first group SLC-spare blocks as three of the SLC-data blocks, writing a second part of the data into third group SLC-spare blocks comprising three of the SLC-spare blocks; and
before the remaining of the data are written into the other SLC-spare blocks, selecting fourth group SLC-data blocks comprising three of the SLC-data blocks which have the oldest valid data from the SLC-data blocks and moving/coping the data stored in the fourth group SLC-data blocks into one of the TLC-spare blocks to release the fourth group SLC-data blocks.

26. The data maintenance method as claimed in claim 23, further comprising before any of the SLC-spare blocks is written, determining whether the number of SLC-spare blocks is less than a predetermined amount, wherein when the number of SLC-spare blocks is less than the predetermined amount the predetermined condition is satisfied.

27. The data maintenance method as claimed in claim 23, wherein when the predetermined condition is not satisfied, the step of writing the data into the SLC-spare blocks further comprises continuously writing the data into the SLC-spare blocks.

28. The data maintenance method as claimed in claim 23, wherein the SLC-spare blocks are SLC blocks that do not have valid data, the SLC-data blocks are SLC blocks that have valid data, and the TLC-spare blocks are TLC blocks that do not have valid data.
